(19) United States
(12) Patent Application Publication
(10) Pub. No.: US 2023/0112359 A1
(43) Pub. Date: Apr. 13, 2023

(54) SHAFT BEARING FOR MOUNTING A SPINNING ROTOR OF A ROTOR SPINNING MACHINE

(71) Applicant: Saurer Spinning Solutions GmbH & Co. KG, Ubach-Palenberg (DE)

(72) Inventors: Michael Jakob, Stuttgart (DE); Dieter Haberkorn, Uhingen (DE); Frank Stocker, Stuttgart (DE)

(73) Assignee: Saurer Spinning Solutions GmbH & Co. KG, Ubach-Palenberg (DE)

(21) Appl. No.: 17/904,613

(22) PCT Filed: Feb. 18, 2021
(86) PCT No.: PCT/EP2021/053933

§ 371 Date: Aug. 19, 2022

(30) Foreign Application Priority Data
Feb. 21, 2020 (DE) 10 2020 104 627.8

(51) Int. Cl. F16C 19/18; F16C 33/58

(52) U.S. Cl. CPC F16C 19/18; F16C 33/58

(57) ABSTRACT

The invention relates to a shaft bearing for mounting a spinning rotor of a rotor spinning machine, with a double-row rolling bearing, which comprises two rolling-body rows that roll on their inner side without an inner ring, on two inner bearing races arranged at a distance from one another on a rotor shaft, and on their outer side on outer bearing races of two separate outer rings. According to the invention, the outer rings are mounted resiliently in a shaft bearing housing so as to provide a shaft bearing for mounting a spinning rotor of a rotor spinning machine with high reliability, even at rotational speeds of more than 110,000 revolutions per minute, which shaft bearing also allows trouble-free operation of a rotor spinning machine equipped with the shaft bearing.

The invention relates to a shaft bearing for mounting a spinning rotor of a rotor spinning machine, comprising a double-row rolling-element bearing having two rows of rolling members, which,
on the inside, roll, without any inner ring, on two inner raceways spaced apart from one another on a rotor shaft, and which,
on the outside, roll on outer raceways

Many different rotor spinning machine configurations are known from the prior art. For rotor spinning machines to function properly, it is essential that the spinning rotor reaches speeds of more than 100,000 revolutions per minute (rpm). Known shaft bearings having double-row rolling-element bearings of the type mentioned at the outset are known, for example, from the documents DE 31 26 892 A1, DE 33 04 912 A1, DE 33 14 547 A1 and DE 20 2010 005 587 U1 and currently enable spinning rotor speeds of up to 110,000 rpm, but do not allow for any higher speeds, due, among other things, to the resonance that occurs at higher speeds. Moreover, in the previously known double-row rolling-element bearings, the high radial stresses that occur at higher speeds lead to rising operating temperatures, which cause damage to the bearing and thus faults in the rotor spinning machine.

On this basis, the problem addressed by the invention is that of providing a shaft bearing for mounting a spinning rotor of a rotor spinning machine that is highly reliable in particular at speeds of more than 110,000 rpm and allows for relatively fault-free operation of a rotor spinning machine equipped with said shaft bearing.

The invention solves the problem by means of a shaft bearing having the features of claim 1. Advantageous further developments of the invention are stated in the dependent claims.

In order to bear the shaft, in particular the rotor shaft of a spinning rotor of a rotor spinning machine, the shaft bearing according to the invention has a double-row rolling-element bearing having two rows of rolling members, forming a first and a second bearing portion, each of which has one row of rolling members arranged coaxially with the rotor shaft. On the inside, the rolling members of the rows of rolling members are borne, without any inner ring, on two inner raceways that are spaced apart from one another in the longitudinal axis direction of the rotor shaft and worked into the surface of the rotor shaft. The shaft bearing according to the invention is characterised in that, on the outside, the rolling members are borne on the outer raceways of two separate outer rings that are spaced apart from one another when viewed in the longitudinal axis direction of the rotor shaft. In addition, the separate outer rings of the first and the second bearing portion are in turn borne in a shaft bearing housing in a resiliently movable manner.

By separating the outer rings and by bearing each outer ring in the shaft bearing housing so as to be resilient independently of one another, it is advantageously possible to implement compensatory movements relative to the shaft bearing housing, unlike with outer rings that are immovably connected to the shaft bearing housing. In other words, depending on the configuration of the resilient mobility, the outer rings can yield in one or more spatial directions. If they are able to move in all spatial directions, the outer rings can be resiliently displaced relative to the shaft bearing housing in the axial, radial and circumferential directions, the movements being dampened depending on the resilient configuration. The ability to yield in a plurality of spatial directions corresponds to Cardanic bearing. The degree of the resilient mobility can also vary between the first and second bearing portion, which, to a limited extent, also enables tilting movements of the rotor shaft relative to the shaft bearing housing.

In the event of bearing-damaging resonance that occurs at high speeds, therefore, the resilient bearing of the outer rings can be effectively compensated for, and so the bearing reduces damaging effects. The shaft bearing according to the invention thus also ensures that the shaft bearing is very durable, even at particularly high speeds of more than 110,000 rpm, thus leading to high operational reliability of a rotor spinning machine equipped with this shaft bearing.

The configuration of the resilient bearing of the outer rings of the two bearing portions in the shaft bearing housing is basically freely selectable. However, according to a preferred embodiment of the invention, the outer rings are borne in the shaft bearing housing by means of at least one bearing member supported against the outer rings and the shaft bearing housing, the at least one bearing member either being formed from a resilient unit, at least in some portions, in the region between the outer rings and the shaft bearing housing, or alternatively enclosing the resilient unit at least in the radial or axial direction of the rotor shaft. According to this preferred embodiment of the invention, the bearing member has, at least in some portions when viewed in the radial direction, a portion that is formed from a resilient unit and that ensures the resilient mobility of the outer rings relative to the shaft bearing housing. The resilient unit particularly reliably allows the outer rings to move relative to the housing while being resiliently deformed. In the process, the resilient unit can be arranged and configured such that the outer rings can resiliently move relative to the shaft bearing housing in the axial, radial and circumferential directions. Using a resilient unit is thus a particularly simple option for providing the mobility, it being possible to adjust the resilient properties through the selection of the resilient unit.

According to the preferred embodiment of the invention in which the resilient unit is enclosed in the radial or axial direction of the rotor shaft, the enclosing effect can preferably be provided such that each bearing member has a bearing member element that is arranged between the resilient unit and the adjacent or subsequent shaft bearing element in the corresponding radial or axial direction. For example, in order to be reliably arranged on an inner surface of the shaft bearing housing, the bearing member can have an adapted first bearing member element, and in order to be arranged on an outer surface of the outer ring, it can have a second bearing member element adapted to the outer ring. The resilient unit is arranged between the first and the second bearing member element and supports the first bearing member element relative to the second bearing member element, thereby making it possible to guarantee the resilient mobility of the outer ring relative to the shaft bearing housing. Using bearing member elements of this kind provides a particularly reliable connection of the bearing member to both the outer ring and the shaft bearing housing. In addition, the resilient unit can be particularly reliably arranged on the first and the second bearing member element such as to guarantee a sturdy connection of the bearing member to both the outer ring and the shaft bearing housing.

Basically, the resilient unit can be connected to the bearing member, for example to the bearing member elements thereof, in any way, but in particular it can be connected thereto by means of gluing.

According to a particularly advantageous further development of the invention, the bearing member is interlocked with the resilient unit at least in the radial or axial direction, further preferably in both the radial and the axial directions, at least on one side, further preferably on all sides. The further preferred configuration of the bearing member such that it is interlocked with the resilient unit in both the radial direction and one or both axial directions particularly reliably guarantees that the resilient unit is arranged on the bearing member in an exceedingly locally stable manner. Preferred axial support, which is provided in addition to radial support and can be achieved, for example, by one or two axial flanges arranged opposite one another and extending radially on the bearing member, can further increase the stability of the connection of the resilient unit to the bearing member.

According to the alternatively preferred embodiment of the invention, the bearing member is formed entirely from a resilient unit. According to this preferred embodiment of the invention, the bearing member is connected directly to the outer ring and to the shaft bearing housing, or is supported directly against said shaft bearing housing. Due to the maximum possible radial extension of the resilient unit, this embodiment of the invention particularly ensures that the outer rings are resiliently movable relative to the shaft bearing housing.

The configuration of the bearing member for supporting the outer rings relative to the shaft bearing housing is basically freely selectable, in addition to the advantageous further developments described above. For instance, according to a particularly simple preferred embodiment of the invention in particular, there is the option to form the bearing member in one piece, said bearing member accordingly extending in the axial direction and being connected to both outer rings. This can be achieved, for example, using a continuous resilient unit that abuts the outer rings, or using a bearing member element that is continuous in accordance with an advantageous preferred further development of the invention and is connected to the resilient unit. According to a particularly preferred embodiment of the invention, however, the outer rings are borne in the shaft bearing housing by means of separate bearing members that are preferably spaced apart from one another when viewed in the longitudinal axis direction of the rotor shaft.

According to this preferred embodiment of the invention, the shaft bearing has two bearing members arranged separately from one another and intended for resiliently bearing the two separate outer rings. This embodiment of the invention makes it possible to use different resilient units having different properties for the two outer rings, whereby the shaft bearing can be optimally adapted to the stresses that occur during operation. By means of this preferred embodiment of the invention, the service life of the shaft bearing, and thus the operating time of a rotor spinning machine equipped with the shaft bearing, can be further increased. The resilient unit for the bearing member can, for example, be selected according to its modulus of elasticity.

According to another preferred embodiment of the invention, in particular where two separate bearing portions spaced apart from one another according to another preferred embodiment of the invention are used, a lubricant reservoir is arranged in the region between the outer rings when viewed in the axial direction of the rotor shaft. Using a lubricant reservoir comprising a lubricant that is suitable for lubricating the bearing portions of the shaft bearing further increases the service life of said bearing, the arrangement in the region between the outer rings ensuring reliable lubricant supply to the two bearing portions and making a compact configuration of the shaft bearing possible.

The configuration of the lubricant reservoir for holding and providing the lubricant is basically freely selectable. According to a particularly preferred embodiment of the invention, however, the lubricant reservoir has a foam member designed to store the lubricant, in particular lubricating oil. Using a foam member ensures reliable holding, storage and provision of lubricant, such that lubrication of the rolling member during operation of the shaft bearing is particularly reliably ensured.

According to a particularly preferred embodiment of the invention, a reservoir support is also provided and separates the lubricant reservoir, in particular the foam member, from the rotor shaft. Using a reservoir support in the form of a spacer in the region between the external members ensures that the lubricant reservoir does not come into contact with the rotating rotor shaft during operation, the rotor shaft thus being able to freely rotate in the shaft bearing while being guided by the bearing portions. Using the reservoir support for holding and positioning the lubricant reservoir relative to the rotor shaft thus further increases the operational reliability of the shaft bearing.

According to a preferred embodiment of the invention, in order to service the shaft bearing and arrange a lubricant in the lubricant reservoir, the shaft bearing housing has at least one closable lubricant filling opening adjacent to the lubricant reservoir. Arranging a filling opening ensures and enables refilling of the lubricant as required during operation, thereby making it possible to further increase the operational life of the shaft bearing since permanent lubrication is reliably ensured.

The configuration of the rolling-element bearing is basically freely selectable. According to a particularly preferred embodiment of the invention, however, the rolling-element bearing is configured as a ball bearing and the rows of rolling members are configured as rows of balls. Using balls as rolling members ensures that forces exerted on the outer rings from the shaft both radially and axially are transmitted particularly reliably.

According to a preferred embodiment of the invention, the resilient unit is formed by a spring element made of a metal material. A spring-biased bearing of this kind is simple and cost-effective to provide and ensures a long service life. Alternatively, according to a preferred embodiment the spring element can be made of a non-metal material or of a combination of a metal material with a non-metal material. Preferably, the non-metal material can be a plastics-containing material.

Spring elements of this kind can be manufactured less expensively than metal materials, and they can be more varied in terms of their possible designs, so more complex shapes can be provided if required.

According to another alternatively preferred embodiment, the resilient unit can be formed by a damping element made of a plastics-containing material, such as an elastomer, a thermoset, a thermoplastic or the like. As another alternative, fluid damping is preferred, in which case the fluid can be a liquid or a gas. Depending on the required resilient bearing properties of the shaft bearing, it is possible to provide a suitable damping type that individually provides various advantages in a known manner. It is also conceivable for the various resilient units to be combined where it appears advantageous to do so depending on the configuration of the shaft bearing and according to the required resilient bearing properties.

Further features and advantages of the invention will become clear from the following description of a preferred embodiment example of the invention, on the basis of the figure and drawing illustrating details essential to the invention, and from the claims. The individual features can be implemented individually or in any desired combination in a preferred embodiment of the invention.

An embodiment example of the invention is explained below with reference to the drawings, in which:

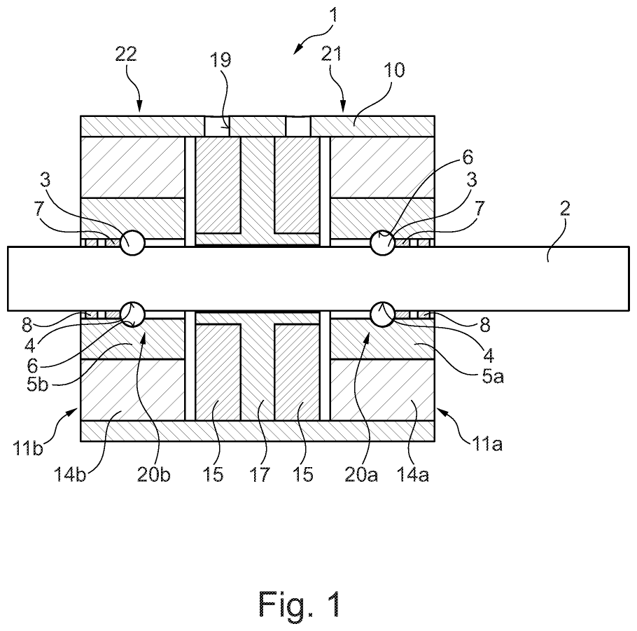

FIG. 1 is a schematic sectional view of an embodiment of a shaft bearing according to a preferred embodiment example.

FIG. 1 is a first sectional view of an embodiment of a shaft bearing 1 for rotatably holding a rotor shaft 2 of a spinning rotor (not shown here) of a rotor spinning machine. To rotatably bear the rotor shaft 2, the shaft bearing 1 has a first and a second bearing portion 21, 22, in each of which the rotor shaft 2 has an inner raceway 4, which are worked into the surface of the rotor shaft 2 in a manner spaced apart from one another in the axial direction. In this preferred embodiment example, the inner raceways 4 are each used for holding rolling members 3, which are configured as balls, of a row 20a, 20b of rolling members of the first and the second bearing portion 21, 22, each row being formed as a row of balls. The rolling members 3 of the rows 20a, 20b of rolling members are in turn borne in outer rings 5a, 5b, which, when viewed in the axial direction, are separate from one another and extend coaxially with the rotor shaft 2, cages 7 fixing the rolling members 3 of the rows 20a, 20b of rolling members in place relative to one another in the circumferential direction.

The outer rings 5a, 5b of the first and the second bearing portion 21, 22, said rings each having an outer raceway 6 for bearing the rolling members 3, are in turn each resiliently displaceably borne in a shaft bearing housing 10 by means of bearing members 11a, 11b. The bearing members 11a, 11bare separate from one another. According to an embodiment example that has not been shown, a common bearing member is provided. In this embodiment example, the bearing member or the bearing members 11a, 11b is/are supported directly against both the outer surface of the outer rings 5a, 5b and the inside of the shaft bearing housing 10 by means of a resilient unit 14a, 14b. According to an embodiment example that has not been shown, in order to be arranged on the outer rings 5a, 5b and on the inside of the shaft bearing housing 10, respectively, the bearing member 11a, 11b can have a first bearing member element abutting the outer surface of the outer rings 5a, 5b and a second bearing member element abutting the inside of the shaft bearing housing 10. In the process, the second bearing member element is supported relative to the associated first bearing member element by means of a resilient unit 14a, 14b. The support by means of the resilient unit 14a, 14b enables resilient movement of the outer rings 5a, 5b, and thus of the rotor shaft 2, in the axial, radial and circumferential directions. Due to its resilient properties, the resilient unit 14a, 14b damps the movements of the rotor shaft 2 in the process.

When viewed in the axial direction of the rotor shaft 2, a lubricant reservoir 15 formed as a foam member is arranged inside the shaft bearing housing 10 between the outer rings 5a, 5b and is spaced apart from the rotor shaft 2 by means of a spacer. For this purpose, the spacer has a reservoir support 17 in the form of a lubricant sleeve that is arranged coaxially with the rotor shaft 2 and which, according to this preferred embodiment example, comprises a circumferential ridge that supports the reservoir support 17 against the inside of the shaft bearing housing 10, the lubricant reservoir 15 thus additionally providing a separate lubricant reservoir 15 for each bearing portion 21, 22. According to an embodiment example that has not been shown, the ridge is permeable to lubricant, or according to another embodiment example that has not been shown, the reservoir support 17 is not configured having a ridge, and so a common lubricant reservoir 15 that supplies both bearing portions 21, 22 is provided.

Filling openings 19 made in the shaft bearing housing 10 are used for filling the lubricant reservoir 15 with lubricant, which is guided inside the shaft bearing housing 10 towards the first and the second bearing portion 21, 22. To prevent lubricant escaping from the shaft bearing 1, the outer rings 5a, 5b are sealed relative to the rotor shaft 2 by means of shaft seals 8.

### LIST OF REFERENCE SIGNS

1 Shaft bearing

2 Rotor shaft

3 Rolling member

4 Inner raceway

5a, 5b Outer ring

6 Outer raceway

7 Cage

8 Shaft seal

10 Shaft bearing housing

11a, 11b Bearing member

14a, 14b Resilient unit

15 Lubricant reservoir

17 Reservoir support

19 Filling opening

20a, 20b Row of rolling members

21 First bearing portion

22 Second bearing portion

1. A shaft bearing (1) for mounting a spinning rotor of a rotor spinning machine, comprising a double-row rolling-element bearing having two rows (20a, 20b) of rolling members, which,
on the inside, roll, without any inner ring, on two inner raceways (4) spaced apart from one another on a shaft, in particular on a rotor shaft (2), and which,
on the outside, roll on outer raceways (6),
wherein on the outside, the rows (20a, 20b) of rolling members roll on outer raceways (6) of two separate outer rings (5a, 5b) that are spaced apart from one another in a longitudinal axis direction of the rotor shaft (2), and
the outer rings (5a, 5b) are in turn borne in a shaft bearing housing (10) in a resiliently movable manner.

2. The shaft bearing (1) according to claim 1, wherein the outer rings (5a, 5b) are borne in the shaft bearing housing (10) by means of at least one bearing member (11a, 11b) supported against the outer rings (5a, 5b) and the shaft bearing housing (10), the at least one bearing member (11a, 11b) either being formed from a resilient unit (14a, 14b), at least in some portions, in the region between the outer rings (5a, 5b) and the shaft bearing housing (10), or enclosing the resilient unit (14a, 14b) at least in a radial or an axial direction of the rotor shaft (2).

3. The shaft bearing (1) according to claim 2, wherein the bearing member (11a, 11b) surrounds the resilient unit (14a, 14b) at least in the radial or axial direction and is interlocked with the resilient unit (14a, 14b) at least on one side in the enclosing direction.

4. The shaft bearing (1) according to either claim 1 or claim 2, wherein the bearing member (11a, 11b) is formed entirely from the resilient unit (14a, 14b).

5. The shaft bearing (1) according to either claim 1 or claim 2, wherein the outer rings (5a, 5b) are borne in the shaft bearing housing (10) by means of separate bearing members (11a, 11b), which are preferably spaced apart from one another.

6. The shaft bearing (1) according to either claim 1 or claim 2, wherein a lubricant reservoir (15) is arranged in the region between the outer rings (5a, 5b).

7. The shaft bearing (1) according to claim 6, wherein lubricant reservoir (15) has a foam member configured for storing the lubricant, in particular lubricating oil.

8. The shaft bearing (1) according to claim 7, wherein a reservoir support (17) which separates the lubricant reservoir (15), in particular the foam member, from the rotor shaft (2).

9. The shaft bearing (1) according to claim 8, wherein the shaft bearing housing (10) has a closable lubricant filling opening (19) adjacent to the lubricant reservoir (15).

10. The shaft bearing (1) according to claim 1, wherein the rolling-element bearing is configured as a ball bearing and the rows (20a, 20b) of rolling members are configured as rows of balls.

11. The shaft bearing (1) according to claim 2, wherein the resilient unit (14a, 14b) is formed by a spring element made of a metal or non-metal material, by a damping element made of a plastics-containing material or by a fluid damping unit.
